(19) United States
(12) Patent Application Publication
(10) Pub. No.: US 2018/0065861 A1
(43) Pub. Date: Mar. 8, 2018

(54) VANADIUM-DIOXIDE-CONTAINING PARTICLES HAVING THERMOCHROMIC PROPERTIES AND METHOD FOR PRODUCING THE SAME

(71) Applicant: Konica Minolta, Inc., Tokyo (JP)

(72) Inventor: Takashi WASHIZU, Hachioji-shi, Tokyo (JP)

(21) Appl. No.: 15/560,023

(22) PCT Filed: Mar. 16, 2016
(86) PCT No.: PCT/JP2016/058398

§ 371 Date: Sep. 20, 2017

(30) Foreign Application Priority Data
Mar. 31, 2015 (JP) 2015-073004

(51) Int. Cl. C01G 31/02; C09K 9/00; C09D 5/26; G02F 1/01

(52) U.S. Cl. CPC C01G 31/02; C09K 9/00; C09D 5/26; C08K 3/22; C01P 2006/32; C01P 2006/60; C01P 2002/72; G02F 1/0147

(57) ABSTRACT

By vanadium-dioxide-containing particles having thermochromic properties and configured such that in an X-ray diffraction spectrum using CuKα as the radiation source, the area of a VO₂ monoclinic peak appearing at 2θ=28°±0.5° and the area of a peak appearing at 2θ=30°±0.5° satisfy a predetermined relation, vanadium-dioxide-containing particles having excellent thermochromic properties are provided.

### TECHNICAL FIELD

The present invention relates to vanadium-dioxide-containing particles having excellent thermochromic properties and a method for producing the same.

### BACKGROUND ART

In buildings such as houses and office buildings, mobile units such as vehicles, and the like, in order to achieve both energy saving and comfortableness, a thermochromic material has been expected be applied to a place (e.g., glazing) where a great heat exchange occurs between the inner part (room interior, vehicle interior) and the external environment.

A “thermochromic material” is a material whose optical properties, such as transmission, can be controlled with temperature. For example, in the case where a thermochromic material is applied to glazing in a building, it can reflect infrared light in summer to block the heat and transmit infrared light in winter to utilize the heat.

One of the thermochromic materials that are currently attracting the most attention is a material containing vanadium dioxide (VO₂). It is known that at the time of phase transition near room temperature, vanadium dioxide (VO₂) exhibits thermochromic characteristics (the property of reversibly changing optical properties with temperature, also referred to as “thermochromic properties”). Accordingly, by utilizing such characteristics, a material that exhibits thermochromic characteristics dependent on the environmental temperature can be obtained.

Here, with respect to vanadium dioxide (VO₂), some polymorphic crystal phases are present, including the A phase, B phase, C phase, and rutile phase (hereinafter sometimes referred to as “R phase”). However, the crystal structure that exhibits the thermochromic characteristics as described above at a relatively low temperature of 100° C. or less is limited to the R phase. The R phase has a monoclinic structure at less than the phase transition temperature (about 68° C.), where the transmittance of visible light and infrared light is high. Meanwhile, the R phase has the property of having a tetragonal structure at the phase transition temperature or higher, where the transmittance of infrared light is lower than in the case of a monoclinic structure.

In order for such vanadium dioxide (VO₂)-containing particles to develop excellent thermochromic characteristics, it is desirable that the particles are not aggregated and have a nano-order size (100 nm or less).

As a method for producing vanadium dioxide (VO₂)-containing particles having thermochromic properties, a method in which R-phase vanadium dioxide (VO₂) particles are produced by a hydrothermal reaction has been reported. For example, Patent Literature 1 describes a method in which using divanadium pentoxide (V₂O₅) or the like as a raw material, a solution containing hydrazine (N₂H₄) or a hydrate thereof (N₂H₄-nH₂O) and water and containing substantially no particles of titanium dioxide (TiO₂) is subjected to a hydrothermal reaction, thereby producing monocrystalline fine particles of vanadium dioxide (VO₂).

### CITATION LIST

### Patent Literature

Patent Literature 1: JP 2011-178825 A

### SUMMARY OF INVENTION

However, the method shown in Patent Literature 1 has a problem in that the fine particles of vanadium dioxide (VO₂) obtained by a hydrothermal reaction are likely to have an increased particle size, resulting in low thermochromic properties.

Thus, the present invention has been accomplished against the above background, and an object thereof is to provide vanadium-dioxide-containing particles having excellent thermochromic properties and a method for producing the same.

The present inventors have conducted extensive research to solve the above problems. As a result, they have found that the above problems are solved by vanadium-dioxide-containing particles configured such that in an X-ray diffraction spectrum using CuKα as the radiation source, the area of a VO₂ monoclinic peak appearing at 2θ=28°±0.5° and the area of a peak appearing at 2θ=30°±0.5° satisfy a predetermined relation.

### BRIEF DESCRIPTION OF DRAWINGS

FIG. 1 is the X-ray diffraction spectrum of the vanadium-dioxide-containing particles obtained in Example 3.

### DESCRIPTION OF EMBODIMENTS

The present inventors have found that vanadium-dioxide-containing particles configured such that in an X-ray diffraction spectrum using CuKα as the radiation source, the area of a VO₂ monoclinic peak appearing at 2θ=28°±0.5° and the area of a peak appearing at 2θ=30°±0.5° satisfy a predetermined relation exhibit excellent thermochromic properties. The detailed mechanism is unclear, but presumably as follows. When vanadium-dioxide-containing particles have a peak appearing at 2θ=30°±0.5° in addition to the peak derived from monoclinic crystals (rutile phase), additional crystal structures other than monoclinic crystals are contained in the vanadium-dioxide-containing particles. As a result, the region having such an additional crystal structure serves as the origin of phase transition and allows for efficient phase transition.

Incidentally, the above mechanism is presumption and does not limit the technical scope of the present invention.

Hereinafter, embodiments of the present invention will be described. Incidentally, the present invention is not limited only to the following embodiments.

As used herein, the expression “X to Y” showing a range means “X or more and Y or less.” In addition, unless otherwise noted, the operations, physical properties, and the like are measured under conditions of room temperature (20 to 25° C.)/relative humidity of 40 to 50% RH.

<Vanadium-Dioxide-Containing Particles>

One embodiment of the present invention is vanadium-dioxide-containing particles having thermochromic properties, configured such that in an X-ray diffraction spectrum using CuKα as the radiation source, the area of a VO₂ monoclinic peak appearing at 2θ=28°±0.5° and the area of a peak appearing at 2θ=30°±0.5° satisfy the relation of the following Equation 1.

[Mathematical Formula 1]

0.03≦(P₂/P₁)≦0.2 Equation (1)

In Equation (1), P₁ is the area of a VO₂ monoclinic peak appearing at 2θ=28°±0.5°, and P₂ is the area of a peak appearing at 2θ=30°±0.5°. As known by those skilled in the art, the 2θ of a peak detected in an X-ray diffraction spectrum includes small measurement errors. Therefore, the peak from which P₁ is calculated may be a VO₂ monoclinic peak whose 2θ appears within a range of 28°±0.5° (i.e., 27.5° to)28.5°, while the peak from which P₂ is calculated may be a peak whose 2θ appears within a range pf 30°±0.5° (i.e., 29.5° to)30.5°. In one embodiment, the peak from which P₁ is calculated is a VO₂ monoclinic peak whose 2θ appears within a range of 28°±0.2° (i.e., 27.8° to)28.2°, while the peak from which P₂ is calculated is a peak whose 2θ appears within a range of 30°±0.2° (i.e., 29.8° to 30.2°).

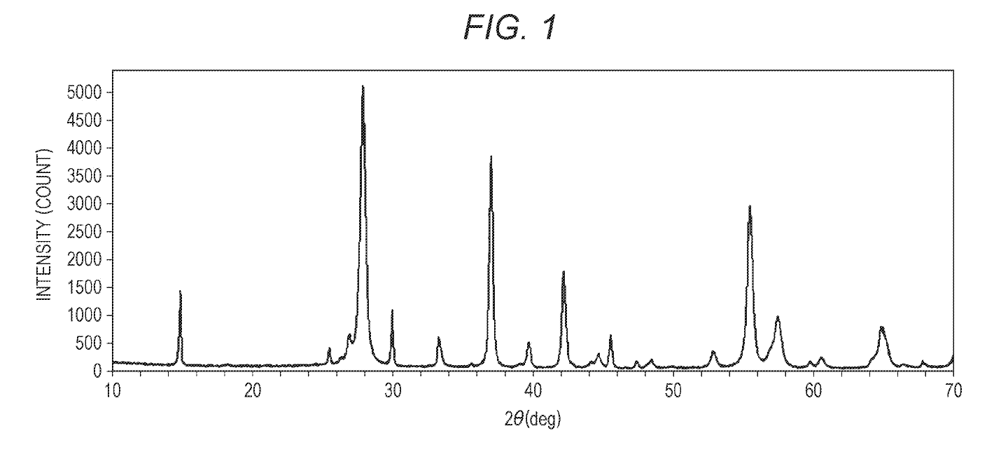

As the X-ray diffraction spectrum of the vanadium-dioxide-containing particles according to the present invention, FIG. 1 shows, as an example, the X-ray diffraction spectrum of the vanadium-dioxide-containing particles of Example 3. As shown in FIG. 1, the vanadium-dioxide-containing particles according to the present invention have peaks whose 2θ (Bragg angle) values appear at 28°±0.5° and 30°±0.5°, respectively (hereinafter, “VO₂ monoclinic peak appearing at 2θ=28°±0.5° ” is sometimes referred to as “peak 1”, and “peak appearing at 2θ=30°±0.5° ” is sometimes referred to as “peak 2”). The vanadium-dioxide-containing particles according to the present invention are characterized in that the area P₁ of the peak 1 and the area P₂ of the peak 2 satisfy the relation of the above Equation (1). Incidentally, as used herein, the “area” of a peak is a value calculated as the product of the height (intensity) and half-width of the peak. In the case where the ratio of P₂ to P₁ (hereinafter the ratio of P₂ to P₁ employed also in Equation (1) is sometimes referred to as “P₂/P₁ value”) is less than 0.03 or more than 0.2, the thermochromic properties of the vanadium-dioxide-containing particles are deteriorated. In terms of thermochromic properties, it is preferable that the P₂/P₁ value is 0.03 to 0.15, more preferably 0.04 to 0.1. The P₂/P₁ value can be reduced by increasing the temperature rise rate in the hydrothermal reaction and increased by reducing the temperature rise rate, for example.

The X-ray diffraction spectrum of the vanadium-dioxide-containing particles according to the present invention should be determined by the following XRD measurement.

(XRD Measurement Conditions)

X-ray diffractometer: RINT2000 (Rigaku Corporation)

Radiation source: CuKα ray

Measurement angle: 2θ=10 to 70°

Scattering slit: ⅓°

Sampling width: 0.02°

Scanning rate: 1.2°/min.

As used herein, “vanadium-dioxide-containing particles” at least contain rutile vanadium dioxide and thus are capable of developing thermochromic properties. The vanadium-dioxide-containing particles may also contain additional elements (dopants) as described below, such as tungsten. It is preferable that in the vanadium-dioxide-containing particles, the amount of vanadium measured by XRD is 90 at % or more, more preferably 95 at % or more (maximum 100 at %), relative to the total amount of vanadium and the dopants. In one embodiment, in the vanadium-dioxide-containing particles, the proportion of vanadium and oxygen measured by XRD is 97.5 at % or more, more preferably 98 at % or more (maximum 100 at %), relative to the entire vanadium-dioxide-containing particles.

By utilizing such vanadium-dioxide-containing particles for a heat shield film or the like, for example, high transmittance of visible light and infrared light can be obtained at a low temperature, and, at a high temperature, the transmittance of infrared light can be reduced while maintaining the high visible light transmittance. The thermochromic properties of the vanadium-dioxide-containing particles are not particularly limited as long as optical properties, such as light transmittance and light reflectance, reversibly vary with changes in temperature. For example, it is preferable that the difference between the light transmittance at 25° C./50% RH and that at 85° C./50% RH (wavelength of 2,000 nm) is 20% or more, more preferably 25% or more, and still more preferably 30% or more. The upper limit of the difference between the light transmittance at 25° C./50% RH and that at 85° C./50% RH is not particularly limited, but is substantially 50% or less, for example. Incidentally, the light transmittance difference is evaluated by the method described in the Examples, for example.

It is preferable that the vanadium-dioxide-containing particles are configured such that in the particle size distribution, the particle size (diameter) at which the cumulative abundance ratio from the small-size side is 80% (D₈₀) is 150 nm or less. When D₈₀ is 150 nm or less, in the case where such vanadium-dioxide-containing particles are used for a transparent film or the like, the haze can be suppressed. Incidentally, in the present invention, the particle size of the vanadium-dioxide-containing particles is measured using a laser diffraction particle size distribution analyzer. For example, a laser diffraction particle size distribution analyzer manufactured by Shimadzu Corporation Co., Ltd., etc., can be used. In the present invention, the abundance ratio is based on the number of particles (number distribution). In one embodiment of the present invention, provided are vanadium-dioxide-containing particles configured such that the particle size at which the cumulative abundance ratio from the small-size side based on the average number of particles by a laser diffraction particle size distribution method is 80% is 150 nm or less. D₈₀ measured by the above method is more preferably 100 nm or less, and still more preferably 50 nm or less. The lower limit of D₈₀ is not particularly limited and may be 1 nm or more, for example. The smaller the particle size of the vanadium-dioxide-containing particles, the greater the specific surface area of the particles; therefore, in the case where such vanadium-dioxide-containing particles are used for a heat shield film or the like, heat can be efficiently absorbed. D₈₀ can be reduced, for example, by reducing the vanadium compound concentration in the reaction mixture during the hydrothermal reaction.

<Method for Producing Vanadium-Dioxide-Containing Particles>

An example of the method for producing vanadium-dioxide-containing particles having excellent thermochromic properties as described above according to the present invention will be shown hereinafter. Incidentally, the method for producing vanadium-dioxide-containing particles according to the present invention is not limited to the following example.

In one embodiment of the present invention, provided is a method for producing vanadium-dioxide-containing particles having thermochromic properties, the method including a step of subjecting a reaction mixture containing a vanadium compound and water to a hydrothermal reaction, thereby forming vanadium-dioxide-containing particles. The temperature rise rate in the hydrothermal reaction is 15 to 80 (° C./h). In vanadium-dioxide-containing particles produced by such a method, P₁ and P₂ satisfy the relation of the above Equation (1) in an X-ray diffraction spectrum using CuKα as the radiation source, offering excellent thermochromic properties. Although the technical scope of the present invention is not limited thereto, this is presumably because of the following mechanism. That is, presumably, when the temperature rise rate is 15° C./h or more and 80° C./h or less, the formation of the crystal structure of the peak 2 (peak appearing at 2θ=30°±0.5° is facilitated.

Hereinafter, the “reaction mixture containing a vanadium compound and water” is sometimes simply referred to as “reaction mixture.”

In the method according to the present invention, examples of raw materials for vanadium-dioxide-containing particles (vanadium compounds) include divanadium pentoxide (V₂O₅), ammonium vanadate (NH₄VO₃), vanadium trichloride oxide (VOCl₃), sodium vanadate (NaVO₃), vanadyl oxalate (VOC₂O₄), vanadium oxide sulfate (VOSO₄), vanadium dichloride oxide (VOCl₂), and divanadium tetraoxide (V₂O₄), as well as hydrates thereof. Among them, in terms of reactivity, it is preferable that the vanadium compound is selected from the group consisting of divanadium pentoxide, ammonium vanadate, vanadium oxide sulfate, and vanadium trichloride oxide, more preferably from the group consisting of divanadium pentoxide, ammonium vanadate, and vanadium trichloride oxide. The vanadium compound is still more preferably divanadium pentoxide and/or ammonium vanadate, and particularly preferably divanadium pentoxide. Incidentally, the vanadium compound may be dissolved or dispersed in the reaction mixture. In addition, it is possible to use a single kind of vanadium compound or use a mixture of two or more kinds. When a tetravalent vanadium compound such as vanadyl oxalate, vanadium oxide sulfate, vanadium dichloride oxide, or divanadium tetraoxide is used, vanadium dioxide can be produced by a hydrothermal reaction without using an oxidizing agent or a reducing agent.

The initial concentration of the vanadium compound contained in the reaction mixture is not particularly limited as long as the object and effect of the present invention can be obtained, but is preferably 0.1 to 500 mmol/L. When the initial concentration of the vanadium compound contained in the reaction mixture is 0.1 mmol/L or more, sufficient reactivity can be obtained. In addition, when the initial concentration of the vanadium compound contained in the reaction mixture is 500 mmol/L or less, the particle size of the resulting vanadium-dioxide-containing particles can be reduced, and the thermochromic properties thereof can be enhanced. In terms of the particle size and thermochromic properties of the vanadium-dioxide-containing particles, the initial concentration of the vanadium compound contained in the reaction mixture is more preferably 0.2 to 300 mmol/L, still more preferably 1 to 130 mmol/L, and particularly preferably 10 to 130 mmol/L. Incidentally, the “initial concentration” is the amount of vanadium compound in 1 L of the reaction mixture before the hydrothermal reaction (in the case where two or more kinds of vanadium compounds are contained, the total amount).

As long as the object and effect of the present invention can be achieved, as the reaction mixture, it is also possible to use a raw material containing additional elements other than vanadium (dopants), such as tungsten, titanium, molybdenum, niobium, tantalum, tin, rhenium, iridium, osmium, ruthenium, germanium, chromium, iron, gallium, aluminum, fluorine, and phosphorus. When the reaction mixture contains additional elements, the phase transition temperature of the resulting vanadium-dioxide-containing particles can be adjusted. An additional element is added as a metal or a compound to the reaction mixture such that the amount of additional element is 0.1 to 5 at %, preferably 0.1 to 1 at %, relative to the total amount of vanadium and the additional element in the reaction mixture. Examples of compounds include oxides of the above metals and salts of the above metals.

The reaction mixture used in the method according to the present invention contains water as a dispersion medium or solvent for the vanadium compound. It is preferable that water contained in the reaction mixture hardly contains impurities. Although the water is not particularly limited, it is possible to use, for example, distilled water, ion exchange water, pure water, ultrapure water, or the like. In one embodiment, the reaction mixture is composed of a vanadium compound, water, and the below-described oxidizing agent and/or reducing agent. In another embodiment, the reaction mixture is composed of a vanadium compound and water.

In the method of the present invention, the reaction mixture may contain an oxidizing agent and a reducing agent. Examples of oxidizing agents and reducing agents are oxalic acid and hydrates thereof, hydrazine and hydrates thereof, and the like. They may be used alone, and it is also possible to use a combination of two or more kinds. The amount of oxidizing agent or reducing agent is not particularly limited and may be 0.01 to 2 mol per mol of the vanadium compound, for example.

In addition, as long as the object and effect of the present invention can be achieved, the reaction mixture may also contain, as a pH adjuster, an organic or inorganic acid or alkali such as hydrochloric acid, sulfuric acid, nitric acid, phosphoric acid, ammonium hydroxide, or ammonia. In terms of the particle size and thermochromic properties of the vanadium-dioxide-containing particles, the pH of the reaction mixture is 4 to 7, for example.

The vanadium compound may be pretreated in the presence of hydrogen peroxide before the hydrothermal reaction. When the vanadium compound is pretreated in the presence of hydrogen peroxide before the hydrothermal reaction, particularly even in the case where a nonionic vanadium compound such as divanadium pentoxide is used, the reaction mixture turns into a sol, allowing the hydrothermal reaction to uniformly proceed. In this case, for example, it is possible that 0.5 to 10 mol of hydrogen peroxide is added to the reaction mixture per mol of the vanadium compound and allowed to react at 20 to 40° C., for example, for 0.5 to 10 hours with stirring as necessary.

The vanadium compound may be subjected to an oxidation reduction reaction in the presence of an oxidizing agent or a reducing agent before the hydrothermal reaction. For example, it is possible that before the hydrothermal reaction described below, the reaction mixture prepared as above is allowed to react at 20 to 40° C., for example, for 0.5 to 10 hours with stirring as necessary. In the case where a plurality of oxidizing agents or reducing agents are employed, the oxidizing agents or reducing agents may be simultaneously or successively added and subjected to the above reaction. The pretreatment with an oxidizing agent or a reducing agent may be performed at the same time with the pretreatment with hydrogen peroxide (i.e., the pretreatment may be performed using a reaction mixture containing hydrogen peroxide and a reducing agent and/or an oxidizing agent), or may also be successively performed separately from the pretreatment with hydrogen peroxide. When an oxidation reduction reaction is carried out before the hydrothermal reaction as described above, this is advantageous in that the production of vanadium dioxide is facilitated.

The method according to the present invention includes a step of subjecting the above reaction mixture to a hydrothermal reaction, thereby forming vanadium-dioxide-containing particles. Incidentally, a “hydrothermal reaction” means a mineral synthesis or modification reaction carried out in the presence of high-temperature water, particularly high-temperature high-pressure water. It is known that unlike the normal-pressure high-temperature conditions where water is hardly present, at a high pressure, specific reactions take place due to the presence of water. In addition, it is also known that the solubility of an oxide such as silica or alumina improves, whereby the reaction rate improves. The hydrothermal reaction can be carried out using a device such as an autoclave or a test-tube reaction vessel.

One characteristic of the method according to the present invention is that the temperature rise rate in the hydrothermal reaction is 15 to 80 (° C./h). In the case where the temperature rise rate is less than 15° C./h or more than 80° C./h, the P₂/P₁ value of the resulting vanadium-dioxide-containing particles is outside the range of the above Equation (1), and the thermochromic properties are deteriorated; therefore, this is undesirable. In terms of the thermochromic properties of the vanadium-dioxide-containing particles, it is preferable that the temperature rise rate in the hydrothermal reaction is 15 to 80° C./h, more preferably 20 to 65° C./h. Incidentally, as long as the temperature rise rate in the hydrothermal reaction is within the above range, the temperature may be raised continuously or stepwise, but is preferably raised continuously. Incidentally, the “temperature rise rate” is a value calculated by (Tm₂ (° C.)-Tm₁ (° C))/t (h), wherein t (h) represents the time to reach the desired maximum hydrothermal reaction temperature (Tm₂ (° C.)) from the temperature before the start of the hydrothermal reaction (Tm₁ (° C.), usually room temperature (25° C.)).

The hydrothermal reaction temperature after the temperature rise (reaction temperature) is not particularly limited and may be suitably set, and is 200° C. to 350° C., for example, preferably 200° C. to 320° C., more preferably 230° C. to 300° C., and still more preferably 250° C. to 300° C. When the temperature is 350° C. or less, the particle size of vanadium-dioxide-containing particles can be reduced, while when the temperature is 200° C. or more, the vanadium-dioxide-containing particles have improved thermochromic properties. In one embodiment of the present invention, the hydrothermal reaction temperature is 200° C. or more and 350° C. or less.

The pressure during the hydrothermal reaction is not particularly limited and may be the saturation water vapor pressure during the hydrothermal reaction, for example. More specifically, the pressure is 5 to 7 MPa, for example. In addition, the time of the hydrothermal reaction is 1 to 120 hours, for example, and preferably 10 to 100 hours. The hydrothermal reaction may be continuous or batchwise.

After the completion of the hydrothermal reaction, it is preferable that the reaction mixture is rapidly cooled to a temperature of 150° C. or less. More preferably, the reaction mixture is cooled to 150° C. or less within 30 minutes after the completion of the hydrothermal reaction.

In addition, it is also possible that the dispersion medium or solvent is replaced by filtration (e.g., ultrafiltration) or centrifugation, and the vanadium-dioxide-containing particles are washed with water, alcohol, or the like. The obtained vanadium-dioxide-containing particles may be dried by an arbitrary means.

<Dispersion>

Another embodiment of the present invention is a dispersion including the vanadium-dioxide-containing particles described above or vanadium-dioxide-containing particles obtained by the above method.

As the dispersion, the reaction mixture after the hydrothermal reaction may be directly used, and it is also possible to add the following water, alcohol, or the like to dilute the reaction mixture after the hydrothermal reaction, or exchange the dispersion medium.

The dispersion medium of the dispersion may be composed only of water, but may also contain, for example, in addition to water, about 0.1 to 10 mass % of an organic solvent (in the dispersion), such as an alcohol (methanol, ethanol, isopropanol, butanol, etc.) or a ketone (acetone, etc.). In addition, as the dispersion medium, it is also possible to use a buffer such as a phosphate buffer or an acetate buffer.

The dispersion may also be adjusted to a desired pH using an organic or inorganic acid or alkali as a pH adjuster, such as hydrochloric acid, sulfuric acid, nitric acid, phosphoric acid, ammonium hydroxide, or ammonia.

In terms of suppressing the aggregation of vanadium-dioxide-containing particles in the dispersion, it is preferable that the pH of the dispersion is 4 to 7.

The vanadium-dioxide-containing particles according to the present invention and vanadium-dioxide-containing particles obtained by the method according to the present invention can be mixed with a resin such as polyvinyl alcohol and utilized for a heat shield film, or utilized for thermochromic pigments, for example.

<Heat Shield Film>

Further, still another embodiment of the present invention is a heat shield film including: a substrate; and an optical functional layer containing the vanadium-dioxide-containing particles of the present invention and a resin.

The substrate applicable to the heat shield film is not particularly limited as long as it is transparent, and examples thereof include glass, quartz, and resin films. However, in terms of imparting flexibility and of production aptitude (process aptitude), it is preferable to use a substrate. In the context of the present invention, when the substrate is “transparent”, this means that the average light transmittance in a visible light region is 50% or more, preferably 60% or more, more preferably 70% or more, and particularly preferably 80% or more.

It is preferable that the thickness of the substrate according to the present invention is within a range of 1 to 200 μm, more preferably within a range of 20 to 100 μm.

As described above, the substrate applicable to the heat shield film according to the present invention is not particularly limited as long as it is transparent, but various resin films are preferably used. Examples thereof include polyolefin films (e.g., polyethylene, polypropylene, etc.), polyester films (e.g., polyethylene terephthalate, polyethylene naphthalate, etc.), polyvinyl chloride, and triacetylcellulose films, and it is preferable that the substrate is a polyester film or a triacetylcellulose. The substrate may also be a stretched film.

On the substrate, an optical functional layer containing a resin and the vanadium dioxide (VO₂)-containing particles according to the present invention is provided. The optical functional layer may include two or more layers.

Here, the resin is not particularly limited, and the same resins as those conventionally used for optical functional layers can be used, and it is preferable to use a water-soluble polymer. Here, a water-soluble polymer refers to such a polymer that 0.001 g or more dissolves in 100 g of water at 25° C. Specific examples of water-soluble polymers include polyvinyl alcohol, polyethyleneimine, gelatin, starch, guar gum, alginate, methylcellulose, ethylcellulose, hydroxyalkylcellulose, carboxyalkylcellulose, polyacrylamide, polyethyleneimine, polyethylene glycol, polyalkylene oxide, polyvinyl pyrrolidone (PVP), polyvinyl methyl ether, carboxyvinyl polymer, polyacrylic acid, sodium polyacrylate, and naphthalenesulfonic acid condensates, as well as proteins such as albumin and caseinate, sodium alginate, dextrin, dextran, and sugar derivatives such as dextran sulfate.

The content of vanadium-dioxide-containing particles in the optical functional layer is 0.1 to 80 mass %, for example, preferably 3 to 50 mass %, relative to the solids content of the optical functional layer.

The optical functional layer may contain known various additives such as anti-fading agents, surfactants, fluorescent brighteners, pH adjusters, antifoamers, lubricants, preservatives, antifungals, antiblocking agents, antistatic agents, matting agents, heat stabilizers, antioxidants, flame retardants, crystal nucleators, inorganic particles, organic particles, viscosity reducers, lubricants, IR absorbers, UV absorbers, dyes, and pigments.

The method for producing a heat shield film (the method for forming an optical functional layer) is not particularly limited, and, except for using the vanadium dioxide (VO₂)-containing particles according to the present invention, a known method may be used in the same manner or after suitable modification. Specifically, a method in which a coating liquid containing the vanadium dioxide (VO₂)-containing particles is prepared, and the coating liquid is applied onto a substrate by a wet-coating method and dried, thereby forming an optical functional layer, is preferable.

In the above method, the wet-coating method is not particularly limited, and examples thereof include a wire bar coating method, a roll coating method, an air knife coating method, a spray coating method, a slide curtain coating method, a slide hopper coating method, and an extrusion coating method.

The thickness of the optical functional layer is not particularly limited either and is 0.1 to 1,000 μm, for example, preferably 1 to 100 μm. Incidentally, in the case where there are a plurality of optical functional layers, the above thickness of the optical functional layer is the total thickness.

In addition to the components described above, the heat shield film of the present invention may further contain additional layers. Here, examples of additional layers include, but are not limited to, an IR absorption layer, a UV absorption layer, a gas barrier layer, a corrosion protection layer, an anchoring layer (primer layer), an adhesive layer, an pressure-sensitive adhesive layer, and a hard coating layer.

### EXAMPLES

The advantageous effects of the present invention will be described hereinafter through examples and comparative examples. However, the technical scope of the present invention is not limited only to the following examples. Incidentally, unless otherwise noted, the operations were performed at 25° C.

### Comparative Example 1

To an aqueous solution prepared by mixing 2 mL of 35 mass % hydrogen peroxide water (manufactured by Wako Pure Chemical Industries, Ltd.) and 20 mL of pure water, 0.55 g of divanadium pentoxide (V₂O₅, special grade, manufactured by Wako Pure Chemical Industries, Ltd.) was added as a vanadium compound, and stirred at 30° C. for 4 hours. Subsequently, 1.4 mL of a 1.25 mol/L aqueous solution of hydrazine monohydrate (N₂H₄-H₂O, special grade, manufactured by Wako Pure Chemical Industries, Ltd.) was slowly added dropwise to the above divanadium pentoxide dispersion and further stirred at 30° C. for 10 minutes, thereby preparing a reaction mixture.

The reaction mixture produced above was placed in an autoclave (high-pressure reaction decomposition vessel, stationary, HU 50-ml set (pressure-resistant outer casing made of stainless steel, sample container made of PTFE) HUTc-50: manufactured by SAN-AI Kagaku Co. Ltd.). In an electric furnace, the temperature was raised from normal temperature (25° C.) to 270° C. over 2.5 hours (temperature rise rate: 98° C./h), and, after 270° C. was reached, a hydrothermal reaction was carried out for 48 hours (pressure: saturation water vapor pressure (5.5 MPa)).

The obtained product was washed using ultrafiltration, thereby producing an aqueous dispersion of vanadium-dioxide-containing particles. Incidentally, ultrafiltration was performed using Vivaflow 50 (manufactured by Sartorius Stedim, effective filtration area: 50 cm², molecular cutoff (Mw): 5,000) at a flow rate of 300 ml/min, a liquid pressure of 1 bar (0.1 MPa), and ordinary temperature.

### Comparative Example 2

To an aqueous solution prepared by mixing 2 mL of 35 mass % hydrogen peroxide water (manufactured by Wako Pure Chemical Industries, Ltd.) and 20 mL of pure water, 0.55 g of divanadium pentoxide (V₂O₅, special grade, manufactured by Wako Pure Chemical Industries, Ltd.) was added as a vanadium compound, and stirred at 30° C. for 4 hours. Subsequently, 1.4 mL of a 1.25 mol/L aqueous solution of hydrazine monohydrate (N₂H₄-H₂O, special grade, manufactured by Wako Pure Chemical Industries, Ltd.) was slowly added dropwise to the above divanadium pentoxide dispersion and further stirred at 30° C. for 10 minutes, thereby preparing a reaction mixture.

The reaction mixture produced above was placed in an autoclave (high-pressure reaction decomposition vessel, stationary, HU 50-ml set (pressure-resistant outer casing made of stainless steel, sample container made of PTFE) HUTc-50: manufactured by SAN-AI Kagaku Co. Ltd.). In an electric furnace, the temperature was raised from normal temperature (25° C.) to 270° C. over 20 hours (temperature rise rate: 12° C./h), and, after 270° C. was reached, a hydrothermal reaction was carried out for 48 hours (pressure: saturation water vapor pressure (5.5 MPa)).

The obtained product was washed using ultrafiltration, thereby producing an aqueous dispersion of vanadium-dioxide-containing particles.

### Example 1

To an aqueous solution prepared by mixing 2 mL of 35 mass % hydrogen peroxide water (manufactured by Wako Pure Chemical Industries, Ltd.) and 20 mL of pure water, 0.55 g of divanadium pentoxide (V₂O₅, special grade, manufactured by Wako Pure Chemical Industries, Ltd.) was added as a vanadium compound, and stirred at 30° C. for 4 hours. Subsequently, 1.4 mL of a 1.25 mol/L aqueous solution of hydrazine monohydrate (N₂H₄-H₂O, special grade, manufactured by Wako Pure Chemical Industries, Ltd.) was slowly added dropwise to the above divanadium pentoxide dispersion and further stirred at 30° C. for 10 minutes, thereby preparing a reaction mixture.

The reaction mixture produced above was placed in an autoclave (high-pressure reaction decomposition vessel, stationary, HU 50-ml set (pressure-resistant outer casing made of stainless steel, sample container made of PTFE) HUTc-50: manufactured by SAN-AI Kagaku Co. Ltd.). In an electric furnace, the temperature was raised from normal temperature (25° C.) to 270° C. over 4 hours (temperature rise rate: 61° C./h), and, after 270° C. was reached, a hydrothermal reaction was carried out for 48 hours (pressure: saturation water vapor pressure (5.5 MPa)).

The obtained product was washed using ultrafiltration, thereby producing an aqueous dispersion of vanadium-dioxide-containing particles.

### Example 2

To an aqueous solution prepared by mixing 2 mL of 35 mass % hydrogen peroxide water (manufactured by Wako Pure Chemical Industries, Ltd.) and 20 mL of pure water, 0.55 g of divanadium pentoxide (V₂O₅, special grade, manufactured by Wako Pure Chemical Industries, Ltd.) was added as a vanadium compound, and stirred at 30° C. for 4 hours. Subsequently, 1.4 mL of a 1.25 mol/L aqueous solution of hydrazine monohydrate (N₂H₄-H₂O, special grade, manufactured by Wako Pure Chemical Industries, Ltd.) was slowly added dropwise to the above divanadium pentoxide dispersion and further stirred at 30° C. for 10 minutes, thereby preparing a reaction mixture.

The reaction mixture produced above was placed in an autoclave (high-pressure reaction decomposition vessel, stationary, HU 50-ml set (pressure-resistant outer casing made of stainless steel, sample container made of PTFE) HUTc-50: manufactured by SAN-AI Kagaku Co. Ltd.). In an electric furnace, the temperature was raised from normal temperature (25° C.) to 270° C. over 12 hours (temperature rise rate: 20° C./h), and, after 270° C. was reached, a hydrothermal reaction was carried out for 48 hours (pressure: saturation water vapor pressure (5.5 MPa)).

The obtained product was washed using ultrafiltration, thereby producing an aqueous dispersion of vanadium-dioxide-containing particles.

### Example 3

To an aqueous solution prepared by mixing 2 mL of 35 mass % hydrogen peroxide water (manufactured by Wako Pure Chemical Industries, Ltd.) and 20 mL of pure water, 0.55 g of divanadium pentoxide (V₂O₅, special grade, manufactured by Wako Pure Chemical Industries, Ltd.) was added as a vanadium compound, and stirred at 30° C. for 4 hours. Subsequently, 1.4 mL of a 1.25 mol/L aqueous solution of hydrazine monohydrate (N₂H₄-H₂O, special grade, manufactured by Wako Pure Chemical Industries, Ltd.) was slowly added dropwise to the above divanadium pentoxide dispersion and further stirred at 30° C. for 10 minutes, thereby preparing a reaction mixture.

The reaction mixture produced above was placed in an autoclave (high-pressure reaction decomposition vessel, stationary, HU 50-ml set (pressure-resistant outer casing made of stainless steel, sample container made of PTFE) HUTc-50: manufactured by SAN-AI Kagaku Co. Ltd.). In an electric furnace, the temperature was raised from normal temperature (25° C.) to 270° C. over 6 hours (temperature rise rate: 41° C./h), and, after 270° C. was reached, a hydrothermal reaction was carried out for 48 hours (pressure: saturation water vapor pressure (5.5 MPa)).

The obtained product was washed using ultrafiltration, thereby producing an aqueous dispersion of vanadium-dioxide-containing particles.

### Example 4

To an aqueous solution prepared by mixing 0.2 mL of 35 mass % hydrogen peroxide water (manufactured by Wako Pure Chemical Industries, Ltd.) and 20 mL of pure water, 0.055 g of divanadium pentoxide (V₂O₅, special grade, manufactured by Wako Pure Chemical Industries, Ltd.) was added as a vanadium compound, and stirred at 30° C. for 4 hours. Subsequently, 0.14 mL of a 1.25 mol/L aqueous solution of hydrazine monohydrate (N₂H₄-H₂O, special grade, manufactured by Wako Pure Chemical Industries, Ltd.) was slowly added dropwise to the above divanadium pentoxide dispersion and further stirred at 30° C. for 10 minutes, thereby preparing a reaction mixture.

The reaction mixture produced above was placed in an autoclave (high-pressure reaction decomposition vessel, stationary, HU 50-ml set (pressure-resistant outer casing made of stainless steel, sample container made of PTFE) HUTc-50: manufactured by SAN-AI Kagaku Co. Ltd.). In an electric furnace, the temperature was raised from normal temperature (25° C.) to 270° C. over 6 hours (temperature rise rate: 41° C./h), and, after 270° C. was reached, a hydrothermal reaction was carried out for 48 hours (pressure: saturation water vapor pressure (5.5 MPa)).

The obtained product was washed using ultrafiltration, thereby producing an aqueous dispersion of vanadium-dioxide-containing particles.

### Example 5

0.35 g of ammonium vanadate (NH₄VO₃, special grade, manufactured by Wako Pure Chemical Industries, Ltd.) was added as a vanadium compound to 20 mL of pure water and stirred at 30° C. for 4 hours. Subsequently, 1.5 mL of a 1.25 mol/L aqueous solution of hydrazine monohydrate (N₂H₄-H₂O, special grade, manufactured by Wako Pure Chemical Industries, Ltd.) was slowly added dropwise to the above aqueous solution of ammonium vanadate and further stirred at 30° C. for 10 minutes, thereby preparing a reaction mixture.

The reaction mixture produced above was placed in an autoclave (high-pressure reaction decomposition vessel, stationary, HU 50-ml set (pressure-resistant outer casing made of stainless steel, sample container made of PTFE) HUTc-50: manufactured by SAN-AI Kagaku Co. Ltd.). In an electric furnace, the temperature was raised from normal temperature (25° C.) to 270° C. over 6 hours (temperature rise rate: 41° C./h), and, after 270° C. was reached, a hydrothermal reaction was carried out for 48 hours (pressure: saturation water vapor pressure (5.5 MPa)).

The obtained product was washed using ultrafiltration, thereby producing an aqueous dispersion of vanadium-dioxide-containing particles.

### Example 6

1.0 g of vanadium oxide sulfate (VOSO₄, Shinko Chemical Co., Ltd.) was added as a vanadium compound to 20 mL of pure water and stirred at 25° C. for 1 hour. Subsequently, 3.0 g of aqueous ammonia diluted to 4 mass % (manufactured by Wako Pure Chemical Industries, Ltd.) was added to adjust pH 8.0 (at 25° C.).

The reaction mixture produced above was placed in an autoclave (high-pressure reaction decomposition vessel, stationary, HU 50-ml set (pressure-resistant outer casing made of stainless steel, sample container made of PTFE) HUTc-50: manufactured by SAN-AI Kagaku Co. Ltd.). In an electric furnace, the temperature was raised from normal temperature (25° C.) to 270° C. over 6 hours (temperature rise rate: 41° C./h), and, after 270° C. was reached, a hydrothermal reaction was carried out for 48 hours (pressure: saturation water vapor pressure (5.5 MPa)).

The obtained product was washed using ultrafiltration, thereby producing an aqueous dispersion of vanadium-dioxide-containing particles.

<Evaluation Method>

From each aqueous dispersion of vanadium-dioxide-containing particles produced by the hydrothermal reaction, the solids were collected by centrifugation, dried at 60° C. for 24 hours, and used in the following various tests.

(XRD Measurement)

The XRD measurement of each of the vanadium-dioxide-containing particles was performed under the following conditions. In the obtained X-ray diffraction spectrum, the area (P₁) of a VO₂ monoclinic peak appearing at 2θ=28°±0.5° and the area (P₂) of a peak appearing at 2θ=30°±0.5° were each determined from the product of the height (intensity) and half-width of the peak, thereby determining the P₂/P₁ value. FIG. 1 shows, as an example, the X-ray diffraction spectrum of the vanadium-dioxide-containing particles obtained in Example 3.

X-ray diffractometer: RINT2000 (Rigaku Corporation)

Radiation source: CuKα ray

Measurement angle: 2θ=10 to 70°

Scattering slit: ⅓°

Sampling width: 0.02°

Scanning rate: 1.2°/min.

(Particle Size Distribution Measurement)

Vanadium-dioxide-containing particles collected as above were mixed with pure water to a concentration of 1 mass %, then ultrasonically dispersed for 15 minutes, and suitably diluted with pure water to give a measurement sample. For the measurement, a laser diffraction particle size distribution analyzer: Model Name SALD-7000 (manufactured by Shimadzu Corporation Co., Ltd.) was used.

(Evaluation of Thermochromic Characteristics)

Using each of the vanadium-dioxide-containing particles produced, pure water was added to a particle concentration of 5 mass %, thereby preparing a dispersion. 20 g of the dispersion was mixed with 90 g of a 10 mass % aqueous solution of polyvinyl alcohol (the amount of vanadium-dioxide-containing particles: 10 mass % relative to the solids content of the layer). Onto a polyethylene terephthalate film (50 μm thick), the above mixture was applied using a wire bar to a dry thickness of 5 μm and dried at 60° C. for 24 hours to give a film for measurement.

Using each film for measurement, the transmittance at a wavelength of 2,000 nm was measured at 25° C./50% RH and also at 85° C./50% RH, and the difference in transmittance between the two was evaluated. The measurement of transmittance was performed using a spectrophotometer V-670 (manufactured by JASCO Corporation) equipped with a temperature control unit (manufactured by JASCO Corporation). The transmittance at a wavelength of 2,000 nm at 85° C./50% RH was subtracted from the transmittance at a wavelength of 2,000 nm at 25° C./50% RH to determine the transmittance difference.

(Haze Measurement)

Using each film for measurement, the haze value was measured using Hazemeter NDH 7000 manufactured by Nippon Denshoku Industries Co., Ltd. A smaller haze value indicates that the film is more excellent as a transparent film.

TABLE 1

| | | 25° C. → | | | Thermochromic | |
|---|---|---|---|---|---|---|
| | | 270° C. | | | Properties | |
| | | Temperature | | | (Transmittance | |
| | Vanadium | Rise Rate | | | Difference | Haze Value |
| | Compound | (° C./h) | P₂/P₁ Value | D₈₀ (nm) | ΔT %) | (%) |
| Comparative | V₂O₅ | 98 | 0.01 | 148 | 15 | 12 |
| Example 1 | | | | | | |
| Comparative | V₂O₅ | 12 | 0.25 | 155 | 13 | 14 |
| Example 2 | | | | | | |
| Example 1 | V₂O₅ | 61 | 0.03 | 152 | 25 | 12 |
| Example 2 | V₂O₅ | 20 | 0.2 | 150 | 23 | 10 |
| Example 3 | V₂O₅ | 41 | 0.06 | 150 | 30 | 10 |
| Example 4 | V₂O₅ | 41 | 0.06 | 45 | 35 | 2 |
| Example 5 | NH₄VO₃ | 41 | 0.06 | 160 | 28 | 15 |
| Example 6 | VOSO₄ | 41 | 0.07 | 155 | 29 | 13 |

This application is based on Japanese Patent Application No. 2015-073004 filed on Mar. 31, 2015, the contents of which are entirely incorporated herein by reference.

1. Vanadium-dioxide-containing particles having thermochromic properties, configured such that in an X-ray diffraction spectrum using CuKα as the radiation source, the area of a VO₂ monoclinic peak appearing at 2θ=28°±0.5° and the area of a peak appearing at 2θ=30°±0.5° satisfy the relation of the following Equation 1:
0.03≦(P₂/P₁)≦0.2 Equation (1)
wherein P₁ is the area of a VO₂ monoclinic peak appearing at 2θ=28°±0.5°, and P₂ is the area of a peak appearing at 2θ=30°±0.5°.

2. The vanadium-dioxide-containing particles according to claim 1, wherein the particle size at which the cumulative abundance ratio from the small-size side based on the average number of particles by a laser diffraction particle size distribution method is 80% is 150 nm or less.

3. A dispersion comprising the vanadium-dioxide-containing particles according to claim 1.

4. A heat shield film comprising:
a substrate; and
an optical functional layer containing the vanadium-dioxide-containing particles according to claim 1 and a resin.

5. A method for producing vanadium-dioxide-containing particles having thermochromic properties,
the method comprising subjecting a reaction mixture containing a vanadium compound and water to a hydrothermal reaction, thereby forming vanadium-dioxide-containing particles,
the temperature rise rate in the hydrothermal reaction being 15 to 80 (°C./h).

6. The method according to claim 5, wherein the temperature of the hydrothermal reaction is 200° C. or more and 350° C. or less.

7. The method according to claim 5, wherein the vanadium compound is selected from the group consisting of divanadium pentoxide, ammonium vanadate, and vanadium trichloride.

8. A dispersion comprising the vanadium-dioxide-containing particles according to claim 2.

9. A heat shield film comprising:
a substrate; and
an optical functional layer containing the vanadium-dioxide-containing particles according to claim 2 and a resin.

10. The method according to claim 6, wherein the vanadium compound is selected from the group consisting of divanadium pentoxide, ammonium vanadate, and vanadium trichloride.
